(19) United States
(12) Patent Application Publication
(10) Pub. No.: US 2010/0115509 A1
(43) Pub. Date: May 6, 2010

(54) POWER OPTIMIZATION VIA VIRTUALIZATION OPPORTUNITY

(75) Inventors: Eric R. Kern, Chapel Hill, NC (US); William G. Pagan, Durham, NC (US); Marc V. Stracuzza, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/262,296

(22) Filed: Oct. 31, 2008

(51) Int. Cl. G06F 9/455; G06F 1/26

(52) U.S. Cl. 718/1

(57) ABSTRACT

Embodiments of the present invention provide a method, system and computer program product for power optimization via virtualization opportunity determination. In an embodiment of the invention, a method for power optimization via virtualization opportunity determination can be provided. The method can include monitoring power utilization in individual server hosts in a cluster and determining a set of the server hosts in the cluster demonstrating low power utilization. The method also can include selecting a subset of server hosts in the set and migrating each VM in non-selected server hosts in the set to the subset of server hosts. Finally, the method can include powering down the non-selected server hosts.

### BACKGROUND OF THE INVENTION

1. Field of the Invention

The present invention relates to the field of virtualization and more particularly to migrating virtual machines in a virtualized environment.

2. Description of the Related Art

The data center has changed over time from a mainframe centric environment requiring dozens of skilled technologists to ensure the ongoing operation of the mainframe, to a complex environment of many different server computing platforms coupled to one another over sophisticated data communications networks. Initially a resource only available to the wealthiest of organizations, recent advances in the mass production of personal computers has provided access to data center technologies at a reasonable cost. Generally facilitated by a rack, the modern data center involves the arrangement of a multiplicity of servers in one or more racks coupled together according to conventional network protocols.

Addressing the unwieldy and unreliable nature of rack-mounted ordinary computers, blade server solutions have become pervasive in more sophisticated data centers. In the blade center environment, different computing platforms can be arranged into blades and coupled to one another across a mid-plane in a single chassis. The mid-plane can provide access to a unified power source, input output (I/O) devices and even removable media drives. In this way, the blades need not include or manage a power supply or commonly used drives within the blades themselves resulting in substantial power savings, a reduced footprint and overall lower total cost of ownership. Additionally, failover concerns can be met through the hot-swappable nature of the blades in the chassis.

Rack mounted arrangements of servers provide a natural platform for deploying a virtualized environment. The virtualized environment embodies virtualization technology. Virtualization as a technology aims to interject a layer between the hardware platform and operating system and executing applications. From the perspective of business continuity and disaster recovery, virtualization provides the inherent advantage of environment portability. Specifically, to move an entire environment configured with multiple different applications is a matter of moving a virtual image from one supporting hardware platform to another. Further, more powerful computing environments can support the coexistence of multiple different virtual images, all the while maintaining a virtual separation between the images. Consequently, a failure condition in one virtual image cannot jeopardize the integrity of other co-executing virtual images in the same hardware platform.

A virtual machine monitor, known in the art as a “hypervisor”, manages the interaction between each virtual image and the underlying resources provided by the hardware platform. In this regard, a bare metal hypervisor runs directly on the hardware platform much as an operating system runs directly on hardware. By comparison, a hosted hypervisor runs within a host operating system. In either case, the hypervisor can support the operation of different “guest operating system images”—known as virtual machine (VM) images—the number of VM images being limited only by the processing resources of a VM container holding the VM images or the hardware platform itself.

Deploying virtualized environments within an arrangement of servers in a cluster permits the ad hoc arrangement of VM images in the cluster. While deploying an ad hoc arrangement of VM images in a cluster more effectively utilizes the computing resources of the underlying servers when compared to a bare metal environment, deploying an ad hoc arrangement of VM images in a cluster is not optimal. Specifically, some VM images will consume more underlying computing resources than other VM images such that one underlying server in a cluster may not adequately provide the requisite computing resource for hosted VM images, while other underlying servers may not completely utilize computing resources available for use by hosted VM images.

### BRIEF SUMMARY OF THE INVENTION

Embodiments of the present invention address deficiencies of the art in respect to deploying and managing VM images in a virtualized environment, and provide a novel and non-obvious method, system and computer program product for power optimization via virtualization opportunity determination. In an embodiment of the invention, a method for power optimization via virtualization opportunity determination can be provided. The method can include monitoring power utilization in individual server hosts in a cluster and determining a set of the server hosts in the cluster demonstrating low power utilization. The method also can include selecting a subset of server hosts in the set and migrating each VM in non-selected server hosts in the set to the subset of server hosts. Finally, the method can include powering down the non-selected server hosts.

In an aspect of the embodiment, monitoring power utilization in individual server hosts in a cluster can include monitoring resource utilization metrics in the individual server hosts, and correlating the metrics with power utilization states. In another aspect of the embodiment, the method yet further can include performing the selecting, migrating and power-down steps only if the determined set of the server hosts exceeds a threshold value. In other aspect of the embodiment, selecting a subset of server hosts in the set and migrating each VM in non-selected ones of the server hosts in the set to the subset of server hosts can include selecting a subset of server hosts in the set, determining an optimal power utilization for each of the server hosts in the subset, monitoring power utilization in each of the server hosts in the subset, and migrating each VM in non-selected ones of the server hosts in the set to the server hosts in the subset only until the determined optimal power utilization of each of the server hosts in the subset has been reached and then discontinuing migration of VMs to ones of the server hosts in the subset determined to have reached optimal power utilization.

In another embodiment of the invention, a virtualized data processing system can be configured for power optimization via virtualization opportunity determination. The system can include a cluster of server hosts. Each of the server hosts can support a hypervisor managing at least one VM. Multiple different management controllers each can be coupled to a corresponding one of the server hosts. Finally, power optimization logic can be communicatively coupled to each management controllers and each hypervisor in each of the server hosts in the cluster.

The logic can include program code enabled to monitor power utilization in individual ones of the server hosts. The program code also can be enabled to determine a set of the server hosts in the cluster demonstrating low power utilization. The program code yet further can be enabled to select a subset of server hosts in the set. The program code even yet further can be enabled to migrate each VM in non-selected ones of the server hosts in the set to the subset of server hosts. Finally, the program code can be enabled to power down the non-selected ones of the server hosts.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for power optimization via virtualization opportunity determination;

FIG. 2 is a schematic illustration of a virtualized data processing system configured for power optimization via virtualization opportunity determination; and,

FIG. 3 is a flow chart illustrating a process for power optimization via virtualization opportunity determination.

### DETAILED DESCRIPTION OF THE INVENTION

Embodiments of the present invention provide a method, system and computer program product for power optimization via virtualization opportunity determination. In accordance with an embodiment of the present invention, power utilization can be monitored in multiple different servers in a cluster. Servers deemed to be in a low power state are determined to be underutilized. When a threshold number of servers are deemed to be in a low power state, VM images hosted within the servers in the low power state can be consolidated in a subset of the servers in the low power state and the remaining server or servers amongst the servers in the low power state can be powered off. In this way, power consumption within the cluster can be optimized.

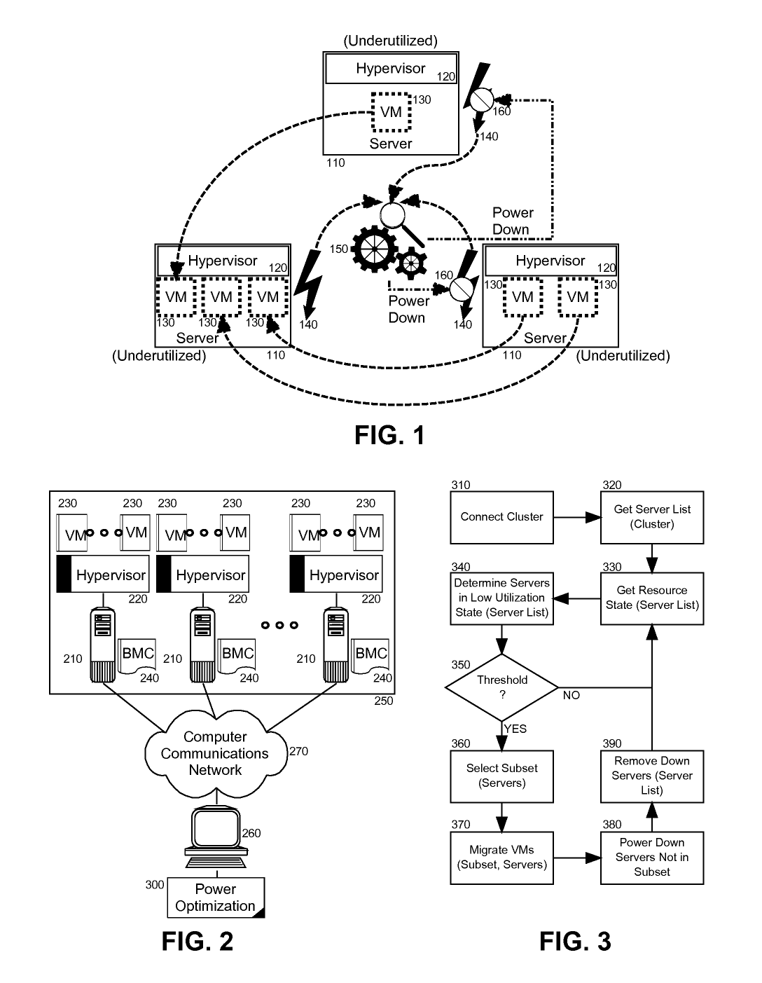

In illustration, FIG. 1 pictorially shows a process for power optimization via virtualization opportunity determination. As shown in FIG. 1, different server hosts 110 in a cluster can support the operation of respective hypervisors 120 managing corresponding virtualized environments of one or more VMs 130. Power optimization logic 150 can monitor each of the server hosts 110 for power utilization 140 by one or more resources in the servers hosts 110, for instance a central processing unit (CPU), fixed disk, memory or communications bus or any combination thereof. In response to detecting underutilization of power in a threshold number of the different server hosts 110, VMs 130 hosted within the underutilized ones of the server hosts 110 can be live migrated to a subset of the underutilized ones of the server hosts 110. Thereafter, the power optimization logic 150 can issue a power-down directive 160 to the remaining ones of the underutilized ones of the server hosts 110 in order to optimize utilization of the subset of the underutilized ones of the server hosts 110.

Notably, the live migration of VMs 130 in to the subset of underutilized ones of the server hosts 110 can be tempered for optimal power utilization in the server hosts 110. In this regard, an optimal power utilization can be determined for each of the server hosts 110 in the subset. Thereafter, during live migration, power utilization can be monitored in each of the server hosts 110 in the subset. Thereafter, the VMs 130 hosted within the underutilized ones of the server hosts 110 can be live migrated to the subset of the underutilized ones of the server hosts 110 only until the determined optimal power utilization of each of the server hosts 110 in the subset has been reached. Subsequently, live migration of the VMs 130 to those server hosts 110 having reached optimal power utilization can be discontinued.

The process described in connection with the power optimization logic 150 of FIG. 1 can be implemented within a virtualized data processing system. In further illustration, FIG. 2 is a schematic illustration of a virtualized data processing system configured for power optimization via virtualization opportunity determination. The system can include a cluster 250 of server hosts 210 each supporting the operation of a virtualized environment managed by a corresponding hypervisor 220. Each hypervisor 220, in turn, can manage the execution of one or more different VMs 230. A management controller 240, such as a baseboard management controller (BMC) can be included with each of the server hosts 210 to monitor resource utilization in the server hosts 210 and to provide an interface to an external management application (not shown) to retrieve metrics associated with the resource utilization.

A computing device 260 can be communicatively coupled to the cluster 250 over a computer communications network 270. The computing device 260 can support the operation of power optimization logic 300 such that the power optimization logic 300 both can access the interface provided by each management controller 240 for each of the server hosts 210, and also can access each hypervisor 220 for each of the server hosts 210. The power optimization logic 300 can include program code enabled to monitor power utilization in each of the server hosts 210 by way of the corresponding ones of the management controllers 240. For example, the power utilization of each of the server hosts 210 can be measured according to a power state of a CPU within each of the server hosts 210, a power state of a fixed disk within each of the server hosts 210, a power state of memory within each of the server hosts 210, or bus utilization within each of the server hosts 210.

The program code further can be enabled to determine based upon the measured power utilization a low power utilization state in one or more of the server hosts 210. The low power utilization state, for example, can be determined by reference to a table correlating the metrics to estimated or empirically determined power utilization states. The program code yet further can be enabled, in response to determining a low power utilization state in a number of the server hosts 210 exceeding a threshold value, to migrate the VMs in the number of the server hosts 210 to a subset of the number of the server hosts 210. The program code even yet further can be enabled to direct the power-down of each remaining host server amongst the number of the server hosts 210 determined to be a low power utilization state. Consequently, power utilization within the cluster can be optimized.

In yet further illustration of the operation of the power optimization logic 300, FIG. 3 is a flow chart illustrating a process for power optimization via virtualization opportunity determination. Beginning in block 310, a communicative linkage can be established with a cluster of server hosts, each supporting a hypervisor managing the execution of one or more VMs. In block 320, a listing of server hosts in the cluster can be retrieved and in block 330, a resource utilization state can be determined for each server host in the server list. In block 340, a set of server hosts in the server list can be identified as being in a low power utilization state. In decision block 350, if the number of server hosts in the list exceeds a threshold value, in block 360, a subset of the server hosts in the set can be selected and in block 370 the VMs in the non-selected server hosts in the set can be migrated to the selected server hosts in the set. Thereafter, the non-selected server hosts can be powered down in block 380 and removed from the server list in block 390. The process can then repeat through block 330.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for power optimization via virtualization opportunity determination, the method comprising:
monitoring power utilization in individual server hosts in a cluster;
determining a set of the server hosts in the cluster demonstrating low power utilization;
selecting a subset of server hosts in the set and migrating each virtual machine (VM) in non-selected ones of the server hosts in the set to the subset of server hosts; and,
powering down the non-selected ones of the server hosts.

2. The method of claim 1, wherein monitoring power utilization in individual server hosts in a cluster, comprises:
monitoring resource utilization metrics in the individual server hosts; and,
correlating the metrics with power utilization states.

3. The method of claim 1, further comprising performing the selecting, migrating and power-down steps only if the determined set of the server hosts exceeds a threshold value.

4. The method of claim 1, wherein selecting a subset of server hosts in the set and migrating each virtual machine (VM) in non-selected ones of the server hosts in the set to the subset of server hosts, comprises:
selecting a subset of server hosts in the set;
determining an optimal power utilization for each of the server hosts in the subset;
monitoring power utilization in each of the server hosts in the subset; and,
migrating each VM in non-selected ones of the server hosts in the set to the server hosts in the subset only until the determined optimal power utilization of each of the server hosts in the subset has been reached and then discontinuing migration of VMs to ones of the server hosts in the subset determined to have reached optimal power utilization.

5. A virtualized data processing system configured for power optimization via virtualization opportunity determination, the system comprising:
a cluster of server hosts, each of the server hosts supporting a hypervisor managing at least one virtual machine (VM);
a plurality of management controllers each coupled to a corresponding one of the server hosts; and,
power optimization logic communicatively coupled to each management controllers and each hypervisor in each of the server hosts in the cluster, the logic comprising program code enabled to monitor power utilization in individual ones of the server hosts, to determine a set of the server hosts in the cluster demonstrating low power utilization, to select a subset of server hosts in the set, to migrate each VM in non-selected ones of the server hosts in the set to the subset of server hosts, and to power down the non-selected ones of the server hosts.

6. A computer program product comprising a computer usable medium embodying computer usable program code for power optimization via virtualization opportunity determination, the computer program product comprising:
computer usable program code for monitoring power utilization in individual server hosts in a cluster;
computer usable program code for determining a set of the server hosts in the cluster demonstrating low power utilization;
computer usable program code for selecting a subset of server hosts in the set and migrating each virtual machine (VM) in non-selected ones of the server hosts in the set to the subset of server hosts; and,
computer usable program code for powering down the non-selected ones of the server hosts.

7. The computer program product of claim 6, wherein the computer usable program code for monitoring power utilization in individual server hosts in a cluster, comprises:
computer usable program code for monitoring resource utilization metrics in the individual server hosts; and,
computer usable program code for correlating the metrics with power utilization states.

8. The computer program product of claim 6, further comprising computer usable program code for performing the selecting, migrating and power-down steps only if the determined set of the server hosts exceeds a threshold value.

9. The computer program product of claim 6, wherein the computer usable program code for selecting a subset of server hosts in the set and migrating each virtual machine (VM) in non-selected ones of the server hosts in the set to the subset of server hosts, comprises:
computer usable program code for selecting a subset of server hosts in the set;
computer usable program code for determining an optimal power utilization for each of the server hosts in the subset;
computer usable program code for monitoring power utilization in each of the server hosts in the subset; and,
computer usable program code for migrating each VM in non-selected ones of the server hosts in the set to the server hosts in the subset only until the determined optimal power utilization of each of the server hosts in the subset has been reached and then discontinuing migration of VMs to ones of the server hosts in the subset determined to have reached optimal power utilization.
